(19) United States
(12) Patent Application Publication
(10) Pub. No.: US 2021/0360309 A1
(43) Pub. Date: Nov. 18, 2021

(54) SET-TOP BOX SYSTEM CONTROLLED BY DIFFERENT PERMISSIONS

(71) Applicant: AMLOGIC (SHANGHAI) CO., LTD., Shanghai (CN)

(72) Inventors: Tao ZENG, Shanghai (CN); Yong WAN, Shanghai (CN)

(21) Appl. No.: 16/325,174

(22) PCT Filed: Sep. 27, 2018
(86) PCT No.: PCT/CN2018/108101

§ 371 Date: Feb. 12, 2019

(30) Foreign Application Priority Data
Oct. 11, 2017 (CN) 201710943870.6

(51) Int. Cl. H04N 21/41; H04N 21/422; G06F 1/3206

(52) U.S. Cl. CPC H04N 21/41265; G06F 1/3206; H04N 21/42221

(57) ABSTRACT

A set-top box system controlled by different permissions comprises: a set-top box body; a first remote controller and a second remote controller, each of which configured to control the set-top box body through infrared signals; wherein a first network access range corresponding to the first remote controller and a second network access range corresponding to the second remote controller are pre-set in the set-top box body; the set-top box body comprises a first wakeup mode and a second wakeup mode; the set-top box body runs in the first/second wakeup mode and is set to the first/second network access range when it is woken up by the infrared signals sent by the first/second remote controller The set-top box system can achieve automatic network switching depending on different remote controllers, and thus, watch requirements from different users on the same set-top box can be satisfied.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### RELATED APPLICATION INFORMATION

This patent claims priority from International PCT Patent Application No. PCT/CN2018/108101, filed Sep. 27, 2018 entitled, SET-TOP BOX SYSTEM CONTROLLED BY DIFFERENT PERMISSIONS, which claims priority to Chinese Application No. 201710943870.6, filed Oct. 11, 2017 entitled, SET-TOP BOX SYSTEM CONTROLLED BY DIFFERENT PERMISSIONS, all of which are incorporated herein by reference in their entirety.

### BACKGROUND OF THE INVENTION

### 1. Field of the Invention

The invention relates to the field of digital information technology, and more particularly, to a set-top box system controlled by different permissions.

### 2. Description of the Related Art

A digital video transform box or a set-top box is a device that connects a television set with an external source of signal. The set-top box can convert the compressed digital signal into content in a form that can be displayed on the television screen. Signals may derive from cables, satellite antennas, broadband network and terrestrial broadcasting. In addition to images and sound provided by an analog TV, the set-top box can also receive digital content, including electronic program guides, internet web pages and subtitles. In this case, users may be allowed to watch digital TV programs on the existing television sets, and interactive digital entertainment, education and commercial activities on the internet can be implemented.

When it comes to the permission of the set-top box, there exist some differences between parents and children. Specifically, use of the set-top box by children, minors in particular, should be limited to some extent, and these restrictions can be set by parents in advance. The existing restriction schemes have some shortcomings. It requires parents to adjust the restriction operation manually, and restrictions are on all users after being imposed, that is to say, even if parents want to watch the restricted contents, they will have to readjust the permission, and manual switching process is quite inconvenient for them.

### SUMMARY OF THE INVENTION

In order to solve the above-mentioned problems in the prior art, the present invention provides a set-top box system controlled by different permissions, comprising: a set-top box body; a first remote controller and a second remote controller, each of which configured to control the set-top box body through infrared signals; wherein a first network access range corresponding to the first remote controller and a second network access range corresponding to the second remote controller are pre-set in the set-top box body; the set-top box body comprises a first wakeup mode and a second wakeup mode; the set-top box body runs in the first wakeup mode and is set to the first network access range when the set-top box body is woken up by the infrared signals sent by the first remote controller; and the set-top box body runs in the second wakeup mode and is set to the second network access range when the set-top box body is woken up by the infrared signals sent by the second remote controller.

In the above-mentioned set-top box system, the set-top box body comprises a communication module for connecting an external communication equipment, and the set-top box body transmits access record information of the set-top box body to the communication equipment via the communication module when the set-top box body is under the control of the second remote controller.

In the above-mentioned set-top box system, the set-top box body comprises a first network channel and a second network channel; when the set-top box body runs in the first wakeup mode, access to network is available from the first network channel; when the set-top box body runs in the second wakeup mode, access to network is available from the second network channel; wherein the second network channel has a preset network restriction policy through which the second network access range is formed.

In the above-mentioned set-top box system, the communication module receives a remote control signal from the communication equipment, and the set-top box body displays communication information on a display device connected to the set-top box body, according to the remote control signal.

In the above-mentioned set-top box system, the communication information is text information.

In the above-mentioned set-top box system, the set-top box body further comprises a clocking module for calculating how long the set-top box body runs in the second wakeup mode; when the running time obtained by the clocking module exceeds a preset period, the set-top box body will enter standby mode automatically and stop responding to the second remote controller.

In the above-mentioned set-top box system, the set-top box body further comprises a timing module for setting a specific period of time when the set-top box body is allowed to run in the second wakeup mode; when the set-top box body runs for a period of time exceeding an allowed period of time set by the timing module, the set-top box body will enter standby mode automatically and stop responding to the second remote controller.

The above-mentioned technical solutions have the following beneficial effects. The present invention provides a set-top box system controlled by different permissions, which can achieve automatic network switching depending on different remote controllers, and thus, watch requirements from different users on the same set-top box can be satisfied.

### BRIEF DESCRIPTION OF THE DRAWINGS

The accompanying drawings, together with the specification, illustrate exemplary embodiments of the present disclosure, and, together with the description, serve to explain the principles of the present invention.

FIG. 1 is a structural diagram of a set-top box system controlled by different permissions according to an embodiment of the present invention.

### DETAILED DESCRIPTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the term “plurality” means a number greater than one.

Hereinafter, certain exemplary embodiments according to the present disclosure will be described with reference to the accompanying drawings.

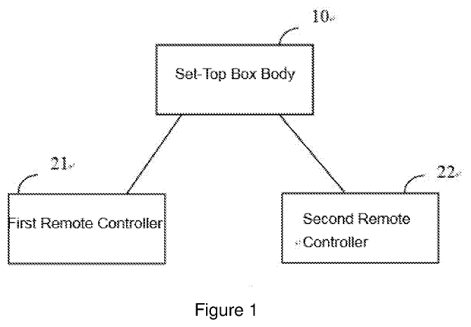

In a preferred embodiment, as shown in FIG. 1, a set-top box system controlled by different permissions is provided, wherein the system comprises: a set-top box body 10; a first remote controller 21 and a second remote controller 22, each of which configured to control the set-top box body 10 through infrared signals; wherein a first network access range corresponding to the first remote controller 21 and a second network access range corresponding to the second remote controller 22 are pre-set in the set-top box body 10; the set-top box body 10 comprises a first wakeup mode and a second wakeup mode; the set-top box body 10 runs in the first wakeup mode and is set to the first network access range when it is woken up by the infrared signals sent by the first remote controller 21; and the set-top box body 10 runs in the second wakeup mode and is set to the second network access range when it is woken up by the infrared signals sent by the second remote controller 22.

In the above-mentioned technical solutions, the set-top box body 10 may further comprise an infrared receiving module for receiving infrared signals from the first remote controller 21 and the second remote controller 22; and a control module, connected to the infrared receiving module and a switching module, respectively, and configured to control the switching module to switch the internet access range according to the infrared signals.

In a preferred embodiment, the set-top box body 10 comprises a communication module for connecting an external communication equipment, and the set-top box body 10 transmits access record information of the set-top box body 10 to the communication equipment via the communication module when the set-top box body 10 is under the control of the second remote controller 22.

In the above-mentioned technical solutions, the communication module can be connected to the control module of the set-top box body 10, and sending of the access record information of the set-top box body 10 can be made upon receiving a sending instruction from the external communication equipment. The access record information may be all the access record information of the set-top box body 10, or some of the access record information of the set-top box body 10 when the set-top box body 10 runs in the second wakeup mode.

In a preferred embodiment, the set-top box body 10 comprises a first network channel and a second network channel; when the set-top box body 10 runs in the first wakeup mode, access to network is available from the first network channel; when the set-top box body 10 runs in the second wakeup mode, access to network is available from the second network channel; wherein the second network channel has a preset network restriction policy through which the second network access range is formed.

In the above-mentioned technical solutions, the entrance to the first network channel and the second network channel may be an access port of the wireless network.

In a preferred embodiment, the communication module receives a remote control signal from the communication equipment, and the set-top box body 10 displays communication information on a display device connected to the set-top box body, according to the remote control signal.

In the above-mentioned technical solutions, the display device may be a television set, or may be other display devices, such as projectors.

In the above-mentioned embodiments, it is preferable that the communication information is text information. The text information may be displayed on a preset position of a display screen of the display device, and may be displayed in the form of rolling display or flickering display.

In a preferred embodiment, the set-top box body 10 further comprises a clocking module for calculating how long the set-top box body 10 runs in the second wakeup mode; when the running time obtained by the clocking module exceeds a preset period, the set-top box body 10 will enter standby mode automatically and stop responding to the second remote controller 22.

In a preferred embodiment, the set-top box body 10 further comprises a timing module for setting a specific period of time when the set-top box body 10 is allowed to run in the second wakeup mode; when the set-top box body 10 runs for a period of time exceeding an allowed period of time set by the timing module, the set-top box body 10 will enter standby mode automatically and stop responding to the second remote controller 22.

In the above-mentioned technical solutions, the clocking module and the timing module can be connected to the control module of the set-top box body 10.

In conclusion, the present invention provides a set-top box system controlled by different permissions, comprising: a set-top box body; a first remote controller and a second remote controller, each of which configured to control the set-top box body through infrared signals; a first network access range corresponding to the first remote controller and a second network access range corresponding to the second remote controller are pre-set in the set-top box body; the set-top box body comprises a first wakeup mode and a second wakeup mode; the set-top box body runs in the first wakeup mode and is set to the first network access range when it is woken up by the infrared signals sent by the first remote controller; and the set-top box body runs in the second wakeup mode and is set to the second network access range when being it is woken up by the infrared signals sent by the second remote controller. The set-top box system controlled by different permissions can achieve automatic network switching depending on different remote controllers, and thus, watch requirements from different users on the same set-top box can be satisfied.

The above descriptions are only the preferred embodiments of the invention, not thus limiting the embodiments and scope of the invention. Those skilled in the art should be able to realize that the schemes obtained from the content of specification and drawings of the invention are within the scope of the invention.

It is claimed:

1. A set-top box system controlled by different permissions, comprising:
a set-top box body;
a first remote controller and a second remote controller, each of which configured to control the set-top box body through infrared signals;
wherein a first network access range corresponding to the first remote controller and a second network access range corresponding to the second remote controller are pre-set in the set-top box body;
the set-top box body comprises a first wakeup mode and a second wakeup mode;
the set-top box body runs in the first wakeup mode and is set to the first network access range when the set-top box body is woken up by the infrared signals sent by the first remote controller; and
the set-top box body runs in the second wakeup mode and is set to the second network access range when the set-top box body is woken up by the infrared signals sent by the second remote controller.

2. The set-top box system as claimed in claim 1, wherein the set-top box body comprises a communication module for connecting an external communication equipment, and the set-top box body transmits access record information of the set-top box body to the communication equipment via the communication module when the set-top box body is under the control of the second remote controller.

3. The set-top box system as claimed in claim 1, wherein the set-top box body comprises a first network channel and a second network channel;
when the set-top box body runs in the first wakeup mode, access to network is available from the first network channel;
when the set-top box body runs in the second wakeup mode, access to network is available from the second network channel;
wherein the second network channel has a preset network restriction policy through which the second network access range is formed.

4. The set-top box system as claimed in claim 1, wherein the communication module receives a remote control signal from the communication equipment, and the set-top box body displays communication information on a display device connected to the set-top box body, according to the remote control signal.

5. The set-top box system as claimed in claim 4, wherein the communication information is text information.

6. The set-top box system as claimed in claim 1, wherein the set-top box body further comprises a clocking module for calculating how long the set-top box body runs in the second wakeup mode; when the running time obtained by the clocking module exceeds a preset period, the set-top box body will enter standby mode automatically and stop responding to the second remote controller.

7. The set-top box system as claimed in claim 1, wherein the set-top box body further comprises a timing module for setting a specific period of time when the set-top box body is allowed to run in the second wakeup mode;
when the set-top box body runs for a period of time exceeding an allowed period of time set by the timing module, the set-top box body will enter standby mode automatically and stop responding to the second remote controller.
